(19) United States
(12) Patent Application Publication
(10) Pub. No.: US 2009/0277625 A1
(43) Pub. Date: Nov. 12, 2009

(54) Compositions For Reducing Or Preventing The Degradation Of Articles Used In A Subterranean Environment And Methods Of Use Thereof

(75) Inventors: YUN BAI, CALGARY (CA); TIMOTHY G.J. JONES, COTTENHAM (GB); BERNADETTE CRASTER, EDMONTON (CA); AHMED HAMMAMI, EDMONTON (CA); TODD YAKIMOSKI, BEAUMONT (CA)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 12/391,497

(22) Filed: Feb. 24, 2009

(30) Foreign Application Priority Data
May 12, 2008 (CA) 2631089

(51) Int. Cl. C09K 3/00; C23F 11/00; B05D 3/00; E21B 17/00

(52) U.S. Cl. 166/65.1; 252/394; 252/395; 252/396; 252/388; 252/389.31; 252/389.1; 427/331; 166/242.2; 166/242.4; 175/320

(57) ABSTRACT

Described herein are compositions for reducing or preventing the degradation of equipment and articles exposed to hydrogen sulfide present in high concentrations in subterranean environments (e.g., oil and gas wells). The compositions are composed of a thermoplastic resin, a thermosetting resin, or a combination thereof, and at least one compound that interacts with hydrogen sulfide from the subterranean environment. In certain aspects, the compositions are coated on the article of interest. In other aspects, the composition is used to manufacture the article and, thus, is integrated throughout the article.

### BACKGROUND OF THE INVENTION

Hydrogen sulfide (H₂S) is often present in the underground water removed with crude oil from a hydrocarbon reservoir, in the crude oil itself, and in the gases associated with such water and oil. The presence of hydrogen sulfide in wellbore fluids introduces a number of materials problems. One major concern is that hydrogen sulfide, being acidic, is highly corrosive to many of the metallic components used in wellbores during drilling, completion, and production operations. For example, sulfide stress cracking (SSC), or sulfide stress corrosion cracking (SSCC), occurs when steel or an alloy reacts with hydrogen sulfide to form metal sulfides and elementary atomic hydrogen. The atomic hydrogen diffuses into the metal matrix, which can make the metal more brittle. The corrosion of expensive downhole equipment is of great concern in view of current demands for crude oil and increasing fuel prices. Thus, what is needed is a way to protect equipment used in subsurface operations from degradation by the high concentrations of hydrogen sulfide frequently found in wellbore fluids.

### BRIEF SUMMARY OF THE INVENTION

Described herein are compositions for reducing or preventing the degradation of equipment and articles exposed to hydrogen sulfide present in high concentrations in subterranean environments during exploration and production operations. The compositions are composed of a thermoplastic resin, a thermosetting resin, or a combination thereof, and at least one compound that interacts with hydrogen sulfide present in the subterranean environment. In certain aspects, the compositions are coated on the article of interest. In other aspects, the composition is used to manufacture the article and, thus, is integrated throughout the article.

The advantages of the materials, methods, and articles described herein will be set forth in part in the description which follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying Figures, which are incorporated in and constitute a part of this specification, illustrate several aspects of the invention described below.

FIG. 1 shows the structure of an H₂S scrubber and the interaction between the H₂S scrubber and H₂S.

FIG. 2 shows a cross-sectional view of a protective layer produced by the compositions described herein adjacent to the surface of an article.

FIG. 3 shows H₂S breakthrough capacity curves of polyamine functionalized silica (PFS) at flow rates of 50 ml/minute and 100 ml/minute with 200ppm H₂S in nitrogen through water and water loaded with PFS.

FIG. 4 illustrates a bismaleimide (BMI) coupon and a BMI coupon loaded with PFS.

### DETAILED DESCRIPTION OF THE INVENTION

Before the present materials, articles, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “an oil” includes a single oil or mixtures of two or more oils.

“Optional” or “optionally” means that the subsequently described event or circumstance may or may not occur, and that the description includes instances where the event or circumstance occurs and instances where it does not.

Described herein are compositions for reducing or preventing the degradation of equipment and articles exposed to hydrogen sulfide present in high concentrations in subterranean environments. In one aspect, the composition is composed of a thermoplastic resin, a thermosetting resin, or a combination thereof, and at least one compound that interacts with hydrogen sulfide present in the subterranean environment (referred to herein as “the H₂S scrubber”). Each component is described below.

The thermoplastic resin and thermosetting resin can be selected from a variety of materials. In general, the resins can be melted such that the H₂S scrubber can be intimately mixed with them. In certain aspects, the resin may also absorb water, which can facilitate the ability of amine-type H₂S scrubbers to interact with H₂S. For example, when the H₂S scrubber is a compound with amine groups, the ability of the resin to absorb water may enhance the overall ability of the H₂S scrubber to remove H₂S from the environment. In certain aspects, the resin can contain functional groups (e.g., amino groups) such that the resin can also function as an H₂S scrubber. The function of H₂S scrubbers is discussed in detail below. Additionally, the resin will minimally degrade when exposed to subterranean conditions (e.g., elevated temperatures, pressure, humidity, acidity, etc.). In certain aspects, the resin can be selected such that it can be applied as a coating.

In other aspects, the resin can include a structural material for additional support. For example, the resin can be composed of a fiber-reinforced plastic (FRP). The fiber-reinforced plastic is composed of a polymer matrix reinforced with fibers. Examples of such fibers include, but are not limited to, fiberglass, carbon, aramid, or basalt, while the polymer can be any of the resins described herein.

In one aspect, the thermoplastic resin includes a polyamide (e.g., polyphthalamide, such as Grivory HT3® available from EMS-CHEMIE Inc. of Sumter, S.C., USA), a polyimide, a polyetherimide (e.g., Ultem® manufactured by SABIC Innovative Plastics of Pittsfield, Mass., USA), a polyamideimide (e.g., Torlon® manufactured by Solvay Advanced Polymers, LLC of Alpharetta, Ga., USA), a polyetherketone, a polyetherketoneketone, a polyetheretherketone, a polyphenylene sulfide, a polyalkylene (e.g., poly(1-butene), poly 4-methyl-1-pentene, or low density polyethyelene as used in Corrosion Intercept® available from Conservation By Design Limited of Bedford, United Kingdom), a polystyrene, a thermoplastic polyurethane, a poly(p-phenylene oxide) (particularly blended with other polymers, such as polystyrene), a polyester (e.g., poly(ethylene terephthalate)) or any combination thereof.

In other aspects, the resin can be a thermosetting resin. Examples of thermosetting resins useful herein include, but are not limited to, an epoxy resin, a cyanate ester resin, a phenolic, a bismaleimide, a polyurethane, an allyl resin, formaldehyde-based thermoset plastics (e.g., melamine formaldehyde, phenol formaldehyde and urea formaldehyde), polyimide-based thermosets (e.g., Duratron® XP available from Boedeker Plastics, Inc. of Shiner, Tex., USA or Pyropel HD available from Albany International Techniweave, Inc. of Rochester, N.H., USA), silicone, a polysiloxane, or any combination thereof. In one aspect, the thermosetting resin includes a bismaleimide produced by the reaction product between 4,4′-bismaleimidophenylmethane and O,O′-diallylbisphenol A. An example of this type of bismaleimide sold commercially is Homide 250 manufactured by HOS-Technik GmbH of St. Stefan, Austria. In other aspects, the bismaleimide resins useful herein include R1155 (UX-BMI), POLYSET 3000, and POLYSET 5000 manufactured by Designer Molecules Inc. of San Diego, Calif., USA.

The H₂S scrubber is any compound or complex that can interact with H₂S. The term “interact” is defined herein as any chemical or physical interaction between the H₂S scrubber and H₂S. For example, one type of interaction can include absorption of H₂S by the H₂S scrubber. Alternatively, the H₂S scrubber may possess one or more groups that react with the H₂S and render H₂S inactive. For example, the H₂S scrubber may possess basic groups that react with H₂S to produce the conjugate base HS⁻. In general, the H₂S scrubber interacts with H₂S in a manner such that H₂S is removed from the subterranean environment and/or rendered inactive (e.g., converting H₂S to another form).

A number of different compounds or complexes can be used as the H₂S scrubber. In certain aspects, the H₂S scrubber is a sorbent including, but not limited to, an inorganic oxide, a clay, a polymeric material, a metal salt or complex, carbon, or a molecular sieve. Examples of inorganic oxides include silver oxide, zinc oxide, iron oxide, aluminum oxide, barium oxide, bismuth oxide, calcium oxide, cadmium oxide, cobalt oxide, copper oxide, potassium oxide, magnesium oxide, molybdenum oxide, sodium oxide, nickel oxide, antimony oxide, lead oxide, tungsten oxide, and tin oxide. Clays such as, for example, montmorillonite can be used as a sorbent for H₂S. In other aspects the H₂S scrubber can be a metal salt or complex of copper, iron, or lead.

In other aspects, the H₂S scrubber includes a solid support and an amine compound. Depending upon the selection of the amine compound and the support, the amine compound can be attached to the support by a number of different techniques. In one aspect, the support can be functionalized with groups that react with an amine group so that the amine compound covalently attaches to the support. In other aspects, the amino group can form non-covalent bonds (e.g., electrostatic, ionic, dipole-dipole, etc.) with the support.

The selection of the support can vary. Examples of inorganic oxides include, but are not limited to, titania, alumina, silica, zirconia, beryllia, and magnesium oxide. Examples of polymers useful herein as a support include plastics such as polymethacrylates and polystyrene. In other aspects, the support can be a clay. For example, amine groups can be attached to clay particles using quaternary ammonium groups by ion exchange onto the clay surface. A polyamine can be lightly quaternized (e.g., by reaction with methyl iodide), to yield an amine-quaternary amine copolymer that can be attached to clay particles. In one aspect, the clay is montmorillonite.

In one aspect, the support is a silica particle. Silica generally possesses surface hydroxyl groups that can form covalent bonds with other groups. For example, organohalosilanes can react with silica to form a new covalent bond (i.e., Si—O—Si). The pendant organohalo group can react with an amine by displacing the halogen and form a new covalent bond. A general procedure for attaching polyamines to silica particles is disclosed in U.S. Pat. No. 5,997,748, which is incorporated herein by reference in its entirety. In one aspect, the silica particle is silica gel. In other aspects, the silica particle has a particle size from less than 1 μm to 1,000 μm, 10 μm to 900 μm, 10 μm to 800 μm, 50 μm to 700 μm, 75 μm to 600 μm, 100 μm to 500 μm, 100 μm to 400 μm, or 100 μm to 300 μm.

The amine compound is any compound having at least one amine group. The term “amine group” is defined herein as a substituted or unsubstituted amino group. The amine group can be an amino group (—NH₂), a primary amine, a secondary amine, or a tertiary amine. When the amine group is substituted, it can be substituted with one or more alkyl groups, aryl groups, cycloalkyl groups, or other organic groups typically known in the art. In certain aspects, the amine compound has a plurality of amino groups (i.e., a polyamine). For example, the polyamine can include a polyallylamine, a polyvinyl amine, or a polyethyleneimine, wherein the polyamine is covalently attached to the silica particle. It is contemplated that linear and branched polyamines can be used herein as well as homopolymers and copolymers thereof. The molecular weight of the polymer can vary depending upon, among other things, the number of amine groups present and the support that is selected.

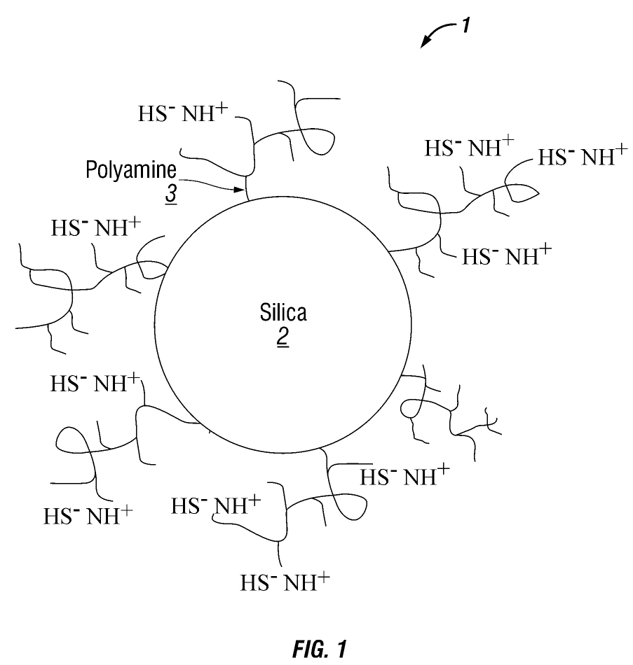

In one aspect, the support includes a silica particle and the amine compound is a polyamine, wherein the polyamine is a polyallylamine, a polyvinyl amine, or a polyethyleneimine, wherein the polyamine is covalently attached to the silica particle. An example of this is depicted in FIG. 1. The H₂S scrubber 1 is composed of a silica particle 2 with a plurality of polyamine compounds 3 attached to the silica particle 2. FIG. 1 shows only one amino group attached to the polyamine 3, however it is understood that a plurality of amino groups can be attached to each polyamine as described above. In one aspect, polyamine functionalized silica (PFS) sold under the tradename WP-1, manufactured by Purity Systems Inc. of Missoula, Mont., USA, may be used herein.

The compositions described herein can be produced using techniques known in the art for formulating resin-based systems. For example, when the resin is a thermoplastic resin, the resin can be heated for a sufficient time and temperature to melt the resin so that the H₂S scrubber can be mixed and dispersed throughout the resin. When the resin is a thermosetting resin, the resin can be heated prior to curing so that the resin melts and permits mixing with the H₂S scrubber. Depending upon the selection of the H₂S scrubber and the concentration of H₂S that is expected in the wellbore fluid, the amount of H₂S scrubber present in the compositions described herein can vary. For example, zinc oxide could be incorporated into a thermoset polymer resin at a volume concentration of 20 percent, where it has a capacity of approximately 0.5 grams of H₂S per milliliter of resin. Similarly, the incorporation of a mole fraction of 0.2 of poly(allylamine) into a bismaleimide resin yields a capacity of approximately 0.1 grams of H₂S per milliliter of resin. Typically, the extent of the incorporation of the H₂S scrubber into the thermoset or thermoplastic resin can be on the order of several tens of percent volume or mole fraction before the thermal and mechanical properties of the base polymer are significantly altered. However, the maximum amount of the H₂S scrubber that can be incorporated into the resin will depend on the chemical composition of the H₂S scrubber and the composition of the resin. In one aspect, the H₂S scrubber can be up to 5 percent, up to 10 percent, up to 15 percent, or up to 20 percent by weight of the composition.

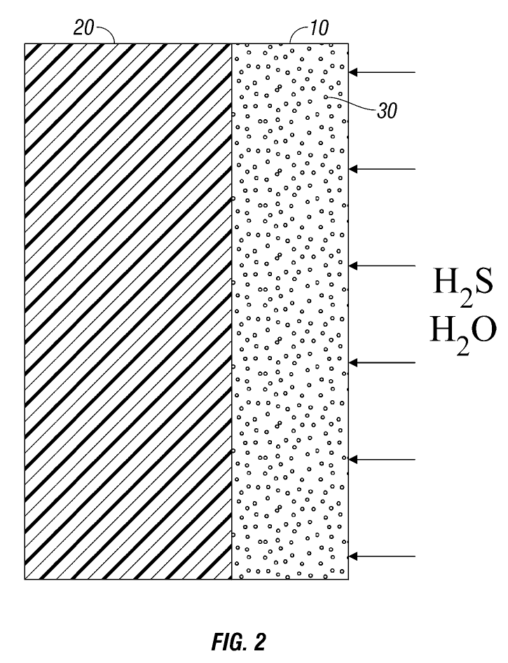

The compositions described herein can prevent or reduce the degradation of an article by hydrogen sulfide present in a subterranean environment. As described above, underground wells can contain high concentrations of H₂S. The presence of H₂S can be problematic for equipment used in drilling, completions, and production operations, as H₂S can be highly corrosive to metallic and polymeric parts. In one aspect, the compositions described herein can be applied to at least one surface of the article that is exposed to hydrogen sulfide present in a subterranean environment. In this aspect, the composition is applied to an exposed surface of the article using techniques known in the art. For example, when the resin is a thermosetting resin, the resin can be melted to permit the H₂S scrubber to be mixed with the resin. The melted mixture can be applied to the surface of the article by spraying, dipping, brushing, rolling, or by other coating techniques, followed by curing the composition to produce a durable protective layer on the surface of the article. This feature is depicted in FIG. 2. The protective layer 10 produced by the composition herein is adjacent to the surface of article 20. Dispersed throughout protective layer 10 is the H₂S scrubber 30. The thickness of the layer can vary depending upon the article to be coated, the conditions of the subterranean environment, and the selection of the resin and H₂S scrubber. The thickness of the coating depends on the geometry of the object to be coated, the mechanical demands made on the object, and the concentration of H₂S to which the object is exposed. In one aspect, a coating thickness in the range 50 μm to 5 mm can be used.

A range of materials and components can be coated with the polymer containing the H₂S scavenger, including sample bottles (interior and exterior), drill pipe, bottomhole assembly, casing, production tubing, completion equipment (e.g., screens, packers, valves, sliding sleeves, electric submersible pumps, chemical flowlines, subsurface electrical cables, and connectors), logging tools (e.g., protection of electronics cartridges), coiled tubing and other subsurface intervention and stimulation equipment. The article to be coated can be composed of a variety of different materials generally used in subsurface operations. In one aspect, the article can be composed of metals such as, iron, stainless steel, or alloys. In other aspects, the article can be a polymeric material. For example, the article can be manufactured of any of the resins described herein (e.g., FRP). In further aspects the article may be a combination of a metal or metals and a polymeric material.

In certain aspects, the article includes a fluoropolymer layer, wherein the composition described herein is applied to the surface of the fluoropolymer layer. The permeability coefficient of hydrogen sulfide in fluorinated polymers is generally low. Thus, a fluoropolymer layer can provide additional protection to the article from H₂S. When a coating of the H₂S scrubber/resin is applied to the fluoropolymer layer, this can further protect the fluoropolymer layer from long-term exposure and damage caused by H₂S. Fluoropolymers such as, for example, Teflon® available from E. I. du Pont de Nemours and Company of Wilmington, Del., USA, can be used herein. In other aspects, the resin with the H₂S scrubber can be mechanically protected by a thin coating of a polymeric material chosen for its strength, such as the polyamide polyimino-1,4-phenyleneiminoterephthaloyl (known commercially as Kevlar® and manufactured by E. I. du Pont) or ultra-high molecular weight polyethylene.

In other aspects, the article can be manufactured with the compositions described herein. For example, if the article is composed of a polymer, the compositions described herein can be molded into any desired shape to produce the article. Depending upon the selection of the resin, the compositions can be used in combination with other polymers to make the article or, in the alternative, the compositions can be used by themselves to produce the article. For example, a polymer nanocomposite composed of a polymer and dispersed clay modified with attached amine groups that can function as the H₂S scrubber can be used to manufacture articles.

The mechanism in which the compositions described herein can prevent or reduce the degradation of an article by H₂S can vary depending upon the selection of the H₂S scrubber. In certain aspects, the H₂S scrubber can absorb H₂S. In other aspects, when the H₂S scrubber is a polyamine compound on a support, the amine groups can react with H₂S via an acid-base reaction. This feature is depicted in FIG. 1, where the amino group on the polyamine 3 deprotonates H₂S to produce the protonated polyamine NH⁺ and the associated counterion HS⁻. In this aspect, the H₂S is rendered inactive by converting it to the unreactive (i.e., noncorrosive) HS⁻. In certain aspects, when the H₂S scrubber involves a polyamine compound, it is desirable in certain aspects that the composition be slightly basic (pH greater than 7.0) to ensure there are a sufficient number of amine groups available to react with the H₂S in the manner described above.

The compositions can be regenerated after they have been applied to the article and can no longer reduce or prevent damage to the article by H₂S. The method of regeneration can vary depending upon the selection of the H₂S scrubber. For example, when the H₂S scrubber is a polyamine on a support, the amine may be regenerated by exchanging HS⁻ ions with OH⁻ ions by soaking the article in a dilute solution of sodium hydroxide. This embodiment is suited to thin coatings that are placed on the surface of polymeric articles since the regeneration time t≈L²/D, where L is the thickness of the coating and D is the diffusion coefficient of the OH⁻ anion in the polyamine film. The extent of the regeneration can be estimated by the reduction in pH and/or the increase in the concentration of HS⁻ ions in the dilute sodium hydroxide solution. In another aspect, when the H₂S scrubber has amine groups, it can be regenerated by exposing the H₂S scrubber to elevated temperatures (e.g., greater than 100° C.) under a flow of pure nitrogen.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Preparation of Bismaleimide Resin/Polyamine Functionalized Silica Composites

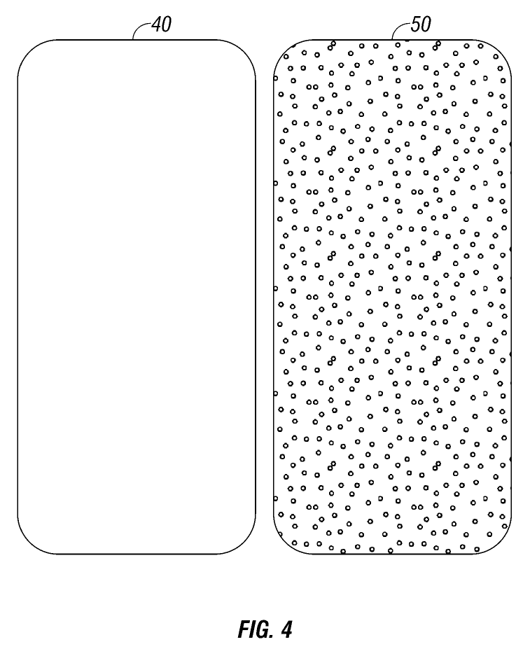

The polyamine functionalized silica (PFS) used is a commercial product, WP-1, available from Purity Systems Inc. The silica size is about 150-250 μm. The bismaleimide (BMI) precursor used is Homide 250. It is an oligomer, which is synthesized from 4,4′-bismaleimidodiphenylmethane (BMPM, Molecular weight=358.35) and O,O′-diallyl bisphenol A (DABPA, Molecular weight=308.41). The BMI precursor is a yellow powder and has a melting temperature of 90-125° C. BMI (80 weight percent) and PFS (20 weight percent) were hand-mixed. The mixture was cured in a rectangular mold at 190° C. for 30 minutes and then post-cured at 230° C. for another 30 minutes. The samples were rectangular in shape with dimensions of 50 mm long, 25 mm wide, and 1 mm thick. The average weight of one coupon is about 1.5 grams. FIG. 4 illustrates a BMI coupon 40 and a BMI coupon containing PFS 50.

### H₂S Absorption by Polyamine Functionalized Silica

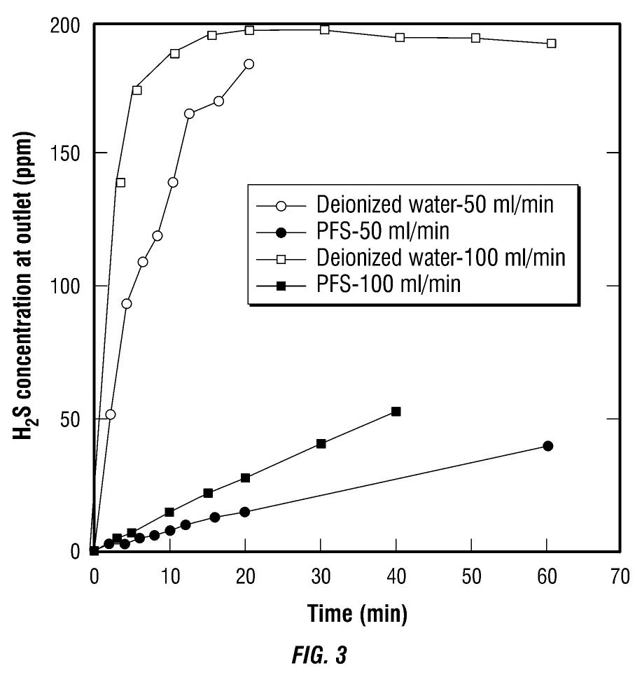

PFS (10 grams) was dispersed in 50 ml of deionized water and magnetically stirred for 24 hours before titrating H₂S. Next, 200 ppm H₂S in nitrogen was bubbled through the dispersion at a flow rate of 50 ml/minute or 100 ml/minute at room temperature and ambient pressure. The blank testing was done with 50 ml deionized water only. The breakthrough data is shown in FIG. 3. FIG. 3 indicates that the PFS absorbs H₂S over time.

### H₂S Absorption Studies of BMI/PFS Composite

H₂S sorption experiments were conducted in a hastalloy aging cell at different temperatures and pressures by exposing the composites to nitrogen gas containing varying amounts of H₂S from 50 ppm to 500 ppm. The connections and lines used were either made of hastalloy or Teflon. After 24 hours, the gas was sampled and analyzed by a sulfur analyzer. The blank testing was done by exposing the blank aging cell to the gas to see if there is any H₂S scrubbed by the cell or the connections. A reference testing was also performed for the stand-alone resins. After the absorption, the samples were taken out and put into a new cell. The new cell was then filled with pure nitrogen (99.99%) and put into an 80° C. water bath to do the desorption. After 24 hours, the gas in the cell was sampled and analyzed.

The BMI/PFS coupons prepared above were soaked in deionized water before H₂S testing and the average water uptake of each coupon was 13±3 weight percent. Four coupons were put into the aging cell in each test and exposed to 100 ppm H₂S in nitrogen (room temperature at 30 psi (cell volume 250 ml)). The blank test was done with the same aging cell. After 24 hours exposure, the gas in the cell was sampled and analyzed by a sulfur analyzer with an accuracy of 0.01 ppm. The results are shown in Table 1. Table 1 indicates that the BMI/PFS coupons absorbed H₂S from the cell when compared to the blank tests.

TABLE 1

| | Blank test | Blank test | BMI/PFS | BMI/PFS | BMI |
|---|---|---|---|---|---|
| | with | without | with | without | without |
| | sample | sample | sample | sample | sample |
| Filled gas | holder | holder | holder | holder | holder |
| Residue H₂S | 40 | 75 | 0 | 0 | 12 |
| concentration | | | | | |
| (ppm ± 2 ppm) | | | | | |

### pH Measurements

The pH of ground BMI, BMI/PFS, and PFS were measured three times in a suspension. In each case, the powder (0.4 grams) was added to 20 ml of deionized water and the suspension was stirred for 22 hours to reach equilibrium. The suspension was filtered and the pH of the collected solution was measured. The pH meter was calibrated with standard solutions at a pH value of 4.00±0.01, 7.00±0.01 and 10.00±0.01. The results in Table 2 indicate that the pH increased with the PFS and BMI/PFS, which signifies that the PFS is still active after it has been incorporated into BMI. The fact that the BMI/PFS composite is slightly basic is further evidence that the composite can absorb H₂S.

TABLE 2

| | pH (±0.01) |
|---|---|
| Cured BMI | 5.36/5.37/5.40 |
| Cured BMI with 20 weight percent PFS | 7.07/7.09/7.10 |
| PFS | 7.75/7.75/7.75 |
| Deionized water | 7.00 |

Various modifications and variations can be made to the compounds, compositions, and methods described herein. Other aspects of the compounds, compositions, and methods described herein will be apparent from consideration of the specification and practice of the compounds, compositions, and methods disclosed herein. It is intended that the specification and examples be considered as exemplary.

What is claimed is:

1. An article used in a subterranean environment, wherein the article comprises a composition comprising a thermoplastic resin, a thermosetting resin, or a combination thereof, and at least one compound that interacts with hydrogen sulfide present in the subterranean environment.

2. The article of claim 1, wherein the composition is applied to at least one surface of the article.

3. The article of claim 1, wherein the article is manufactured with the composition.

4. The article of claim 1, wherein the thermoplastic resin comprises a polyamide, a polyimide, a polyetherimide, a polyamideimide, a polyetherketone, a polyetherketoneketone, a polyetheretherketone, a polyphenylene sulfide, a polyalkylene, a polystyrene, a thermoplastic polyurethane, a poly(p-phenylene oxide), a polyester or any combination thereof.

5. The article of claim 1, wherein the thermosetting resin comprises an epoxy resin, a cyanate ester resin, a phenolic, a bismaleimide, a polyurethane, an allyl resin, a formaldehyde-based thermoset plastic, a polyimide-based thermoset, silicone, a polysiloxane, or any combination thereof.

6. The article of claim 1, wherein the thermosetting resin comprises a bismaleimide, and wherein the bismaleimide comprises the reaction product between 4,4′-bismaleimidophenylmethane and O,O′-diallylbisphenol A.

7. The article of claim 1, wherein the thermoplastic resin, the thermosetting resin, or a combination thereof is reinforced with fibers.

8. The article of claim 7, wherein the fibers comprise fiberglass, carbon, aramid, or basalt.

9. The article of claim 1, wherein the at least one compound comprises a solid support and an amine compound.

10. The article of claim 9, wherein the support comprises an inorganic oxide, a clay, or a polymeric material.

11. The article of claim 9, wherein the support comprises a silica particle and the amine compound comprises a polyamine, wherein the polyamine comprises a polyallylamine, a polyvinyl amine, or a polethyleneimine, wherein the polyamine is covalently attached to the silica particle.

12. The article of claim 11, wherein the silica particle has a particle size from less than 1 μm to 1,000 μm.

13. The article of claim 11, wherein silica particle has a particle size from 100 μm to 300 lam.

14. The article of claim 1, wherein the at least one compound comprises a hydrogen sulfide sorbent, wherein the sorbent comprises an inorganic oxide, a clay, a polymeric material, a metal salt or complex, carbon, or a molecular sieve.

15. The article of claim 1, wherein the at least one compound comprises a metal salt or complex of copper, iron, or lead.

16. The article of claim 1, wherein when the at least one compound comprises amine groups, the composition has a pH of greater than 7.0.

17. The article of claim 1, wherein the article comprises at least one surface, wherein a fluoropolymer is applied to the at least one surface to produce a fluoropolymer layer, and the composition is applied to the surface of the fluoropolymer layer.

18. The article of claim 1, wherein the article comprises a drill pipe, a bottomhole assembly, a casing, a production tubing, completion equipment, a logging tool, or a coiled tubing.

19. The article of claim 1, wherein the article is manufactured of a material comprising metal, a polymeric material, or a combination thereof.

20. The article of claim 19, wherein the metal comprises iron, stainless steel, or an alloy.

21. The article of claim 19, wherein the polymeric material comprises a thermoplastic resin, a thermosetting resin, or a combination thereof.

22. The article of claim 21, wherein the thermoplastic resin, the thermosetting resin, or a combination thereof is reinforced with fibers.

23. A method for preventing or reducing degradation of an article used in an environment by hydrogen sulfide, the method comprising applying a composition on at least one surface of the article, wherein the composition comprises a thermoplastic resin, a thermosetting resin, or a combination thereof, and at least one compound that interacts with hydrogen sulfide from the environment.

24. The method of claim 23, wherein the article is a sample bottle, drill pipe, a bottomhole assembly, casing, production tubing, completion equipment, a logging tool, or coiled tubing.

25. The method of claim 23, wherein the at least one compound is a polyamine on a support, the method further comprising regenerating the amine by exchanging HS— ions with OW ions by soaking the article in a dilute solution of sodium hydroxide.

26. A method for preventing or reducing degradation of an article used in an environment by hydrogen sulfide, the method comprising manufacturing the article with a composition comprising a thermoplastic resin, a thermosetting resin, or a combination thereof, and at least one compound that interacts with hydrogen sulfide from the environment.

27. A composition for removing hydrogen sulfide from an environment, wherein the composition comprises a thermoplastic resin, a thermosetting resin, or a combination thereof, wherein the thermoplastic resin, the thermosetting resin, or a combination thereof is reinforced with fibers, and wherein the composition further comprises at least one compound that interacts with hydrogen sulfide from the environment.
